(19) United States
(12) Patent Application Publication
(10) Pub. No.: US 2012/0017241 A1
(43) Pub. Date: Jan. 19, 2012

(54) HANDHELD DEVICE AND TEXT INPUT METHOD

(75) Inventors: CHUNG-CHIH YEH, Tu-Cheng (TW); CHIAO-YING WU, Tu-Cheng (TW)

(73) Assignee: HON HAI PRECISION INDUSTRY CO., LTD., Tu-Cheng (TW)

(21) Appl. No.: 13/072,761

(22) Filed: Mar. 27, 2011

(30) Foreign Application Priority Data
Jul. 19, 2010 (CN) 201010231183.X

(51) Int. Cl. H04N 5/445

(52) U.S. Cl. 725/37

(57) ABSTRACT

A handheld device establishes a wireless connection with an Internet television including a television display, sends a detection message to the Internet television, and then receives a first feedback from the Internet television. The handheld device determines whether a cursor of the television display shows a text input area of the television display according to the first feedback, and determines a text type of the text input area if the cursor shows the text input area. The handheld device selects one input method corresponding to the text type of the text input area, and inputs a text in the text input area by use of the corresponding input method.

### BACKGROUND

1. Technical Field

The present disclosure relates to communication terminals, and more particularly to a handheld device and a text input method.

2. Description of Related Art

With the advent of Internet televisions (TVs), interactions between Internet televisions and users become more frequent. For example, users often need to utilize remote controllers to input text to the Internet televisions.

However, use of the remote controllers to input text to the Internet televisions via an on-screen keyboard, which is very unfriendly and slow.

### BRIEF DESCRIPTION OF THE DRAWINGS

The details of the disclosure, both as to its structure and operation, can best be understood by referring to the accompanying drawings, in which like reference numbers and designations refer to like elements.

FIG. 1 is schematic diagram of an application environment and function modules of one embodiment of a handheld device in accordance with the present disclosure;

FIG. 2 is a flowchart of one embodiment of a text input method in accordance with the present disclosure; and

FIG. 3 is a flowchart of another embodiment of a text input method in accordance with the present disclosure.

### DETAILED DESCRIPTION

All of the processes described may be embodied in, and fully automated via, software code modules executed by one or more general purpose computers or processors. The code modules may be stored in any type of computer-readable medium or other storage device. Some or all of the methods may alternatively be embodied in specialized computer hardware or communication apparatus.

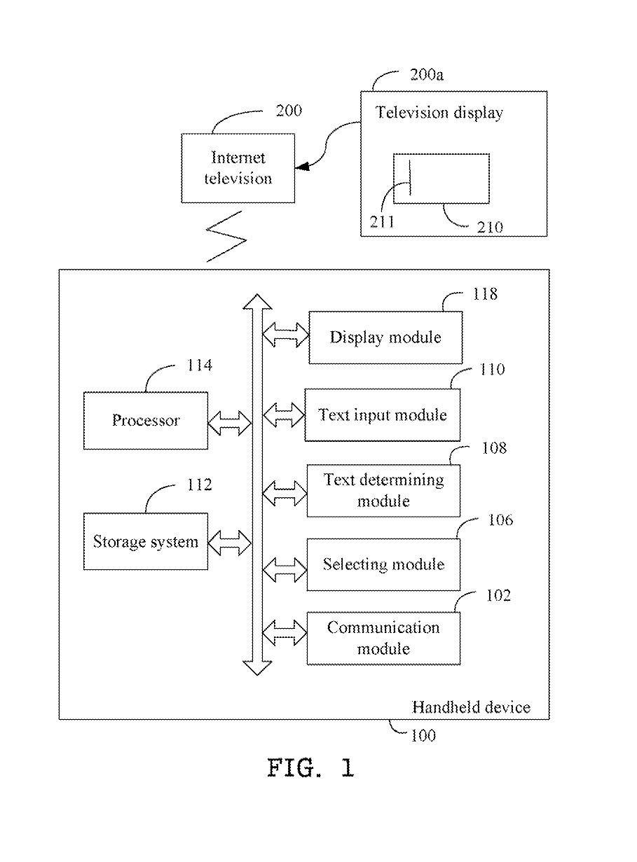

FIG. 1 is schematic diagram of an application environment and function modules of one embodiment of a handheld device 100 in accordance with the present disclosure. In one embodiment, the handheld device 100 can replace with a remote controller to input text to an Internet television (otherwise known as Internet TV, or Online TV) 200. The Internet television 200 is a television that is electronically connected and communicates with a television service distributed via the Internet, which allows users to choose a program from an archive of programs or a channel directory.

In one non-limiting example, the handheld device 100 may be a mobile phone, a mobile Internet device (MID), a palm computer, or another handheld device with a plurality of input methods.

In one embodiment, the Internet television 200 includes a television display 200a that uses a cursor 211 to show a text input area 210.

The handheld device 100 includes a communication module 102, a selecting module 106, a text determining module 108, a text input module 110, a storage system 112, and at least one processor 114. The modules 102-110 may comprise computerized code in the form of one or more programs that are stored in the storage system 112. The computerized code includes instructions that are executed by the at least one processor 114 to provide functions for the modules 102-110. In one example, the storage system 112 may be a hard disk drive, flash memory, or other computerized memory device.

The storage system 112 is further operable to store a plurality of input methods corresponding to a plurality of text types. In one non-limiting example, if the text type is English, the corresponding input method may be an English input method such as Triivi or Swiftkey. If the text type is a Chinese character, the corresponding input method may be a Chinese input method such as five stroke input method or Zheng code input method.

The communication module 102 is operable to establish a wireless connection with the Internet television 200, send a detection message to the Internet television 200, and receive a first feedback corresponding to the detection message from the Internet television 200. The detection message is an electronic message that is used to request the Internet television 200 to detect a text input area status of the television display 200a, and the first feedback is an electronic message that includes the text input area status of the television display 200a. For example, the text input area status includes information about the cursor 211 and the text input area 210 of the television display 200a.

The text determining module 108 is operable to determine whether the cursor 211 of the television display 200a shows the text input area 210 of the television display 200a according to the first feedback, and determines a text type of the text input area 210 according to the first feedback when the cursor 211 shows the text input area 210.

The selecting module 106 is operable to select one input method that corresponds to the text type of the text input area 210 from the input methods stored in the storage system 112. For example, assuming the text type of the text input area 210 is English, the corresponding input method may be a Swiftkey or Triivi.

The text input module 110 is operable to input text in the text input area 210 by use of the corresponding input method.

Then, the communication module 102 transmits the input text to the Internet television 200, and receives a second feedback corresponding to the input text from the Internet television 200. The second feedback includes a plurality of complete words related to the input text. For example, if the input text is “a”, the plurality of complete words included in the second feedback may include “Alibaba”, “Aloddin”, “Apocalypse”, and “Avator”.

Afterwards, the text input module 110 determines whether the input text is a complete word. In one non-limiting example, if the input text is “A”, “Av”, “Avat”, then the input text is not a complete word. If the input text is “Avator”, then the input text is a complete word.

If the input text is not a complete word, the text input module 110 further determines whether remaining text is input by the corresponding input method. If the remaining text is input by the corresponding input method, the text input module 110 continues to input the remaining text by the corresponding input method.

If the remaining text is not input by the corresponding input method, the text input module 110 selects one complete word from the complete words included in the second feedback. For example, assuming the plurality of complete words included in the second feedback may include “Alibaba”, “Aloddin”, “Apocalypse”, and “Avator”, the text input method 110 may select “Avator”. Then the communication module 102 transmits the selected complete word “Avator” to the Internet television 200.

In one embodiment, the handheld device 100 may further include a display module 118, operable to display the input text, the complete words included in the second feedback, and the selected complete word. In one embodiment, the input text, the complete words included in the second feedback, and the selected complete word may be displayed on both the television display 200a of the Internet television 200 and the display module 118 of the handheld device 100.

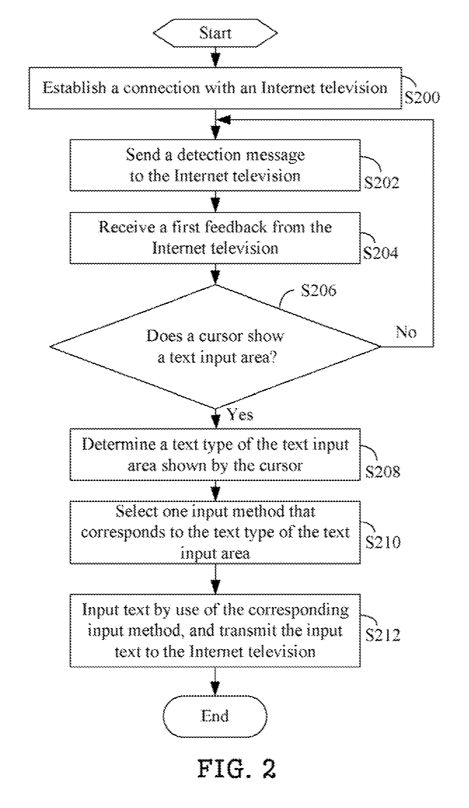

FIG. 2 is a flowchart of one embodiment of a text input method in accordance with the present disclosure. In one embodiment, the text input method may be embodied in the handheld device 100, and is executed by the functional modules such as those of FIG. 1. Depending on the embodiment, additional blocks may be added, others deleted, and the ordering of the blocks may be changed while remaining well within the scope of the disclosure.

In block S200, the communication module 102 establishes a wireless connection with the Internet television 200. In one example, the wireless connection may be Bluetooth or WIFI.

In block S202, the communication module 102 sends a detection message to the Internet television 200.

In block S204, the communication module 102 receives a first feedback corresponding to the detection message from the Internet television 200.

In one embodiment, the detection message is an electronic message that is used to request the Internet television 200 to detect a text input area status of the television display 200a, and the first feedback is an electronic message that includes the text input area status of the television display 200a. For example, the text input area status includes information about the cursor 211 and the text input area 210 of the television display 200a.

In block S206, the text determining module 108 determines whether the cursor 211 of the television display 200a shows the text input area 210 of the television display 200a according to the first feedback.

If the cursor 211 of the television display 200a does not point at the text input area 210 of the television display 200a, going back to block S202, the communication module 102 continues to send the detection message to the Internet television 200.

If the cursor 211 of the television display 200a shows the text input area 210 of the television display 200a, in block S208, the text determining module 108 determines a text type of the text input area 210 according to the first feedback.

In block S210, the selecting module 106 selects one input method that corresponds to the text type of the text input area 210 from the input methods stored in the storage system 112. For example, assuming the text type of the text input area 210 is English, the corresponding input method may be a Swiftkey or Triivi.

In block S212, the text input module 110 inputs a text in the text input area 210 by use of the corresponding input method, and the communication module 102 transmits the input text to the Internet television 200.

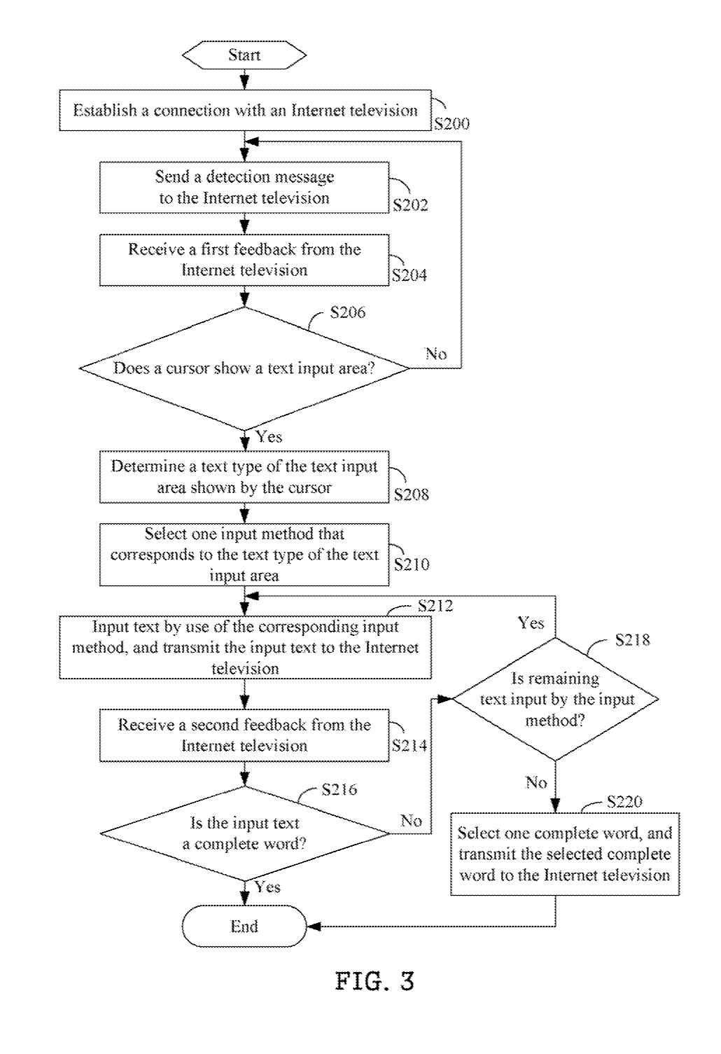

FIG. 3 is a flowchart of another embodiment of a text input method in accordance with the present disclosure. The text input method of FIG. 3 is similar to the text input method of FIG. 2, and the difference is that the text input method of FIG. 3 further includes blocks S214-220.

In block S214, the communication module 102 receives a second feedback corresponding to the input text from the Internet television 200. In one embodiment, the second feedback includes a plurality of complete words related to the input text. For example, if the input text is “A”, the plurality of complete words included in the second feedback may include “Alibaba”, “Aloddin”, “Apocalypse”, and “Avator”.

In block S216, the text input module 110 determines whether the input text is a complete word. In one non-limiting example, if the input text is “A”, “Av”, “Avat”, then the input text is not a complete word. If the input text is “Avator”, the input text is a complete word.

If the input text is not a complete word, in block S218, the text input module 110 further determines whether remaining text is input by the corresponding input method.

If the remaining text is input by the corresponding input method, going back to block S212, the text input module 110 continues to input the remaining text by the corresponding input method.

If the remaining text is not input by the corresponding input method, in block S220, the text input module 110 selects one complete word from the complete words included in the second feedback, and the communication module 102 transmits the selected complete word to the Internet television 200. For example, assuming the plurality of complete words included in the second feedback may include “Alibaba”, “Aloddin”, “Apocalypse”, and “Avator”, the text input module 110 may select “Avator” and the communication module 102 transmits “Avator” to the Internet television 200.

In conclusion, the handheld device 100 can use one input method corresponding to the text input area 210 shown by the cursor 211 of the television display 200a, and inputs a complete word to the text input area 210 of the television display 200a by use of the corresponding input method. Thus, the handheld device 100 does not need one on-screen keyboard to input the complete word to the television display 200a of the Internet television 200, which is very friendly and has a quick speed.

While various embodiments of the present disclosure have been described above, it should be understood that they have been presented using example and not using limitation. Thus the breadth and scope of the present disclosure should not be limited by the above-described embodiments, but should be defined in accordance with the following claims and their equivalents.

What is claimed is:

1. A handheld device wirelessly communicating with an Internet television comprising a television display, the handheld device comprising:
a storage system operable to store a plurality of input methods corresponding to a plurality of text types;
at least one processor;
one or more programs that are stored in the storage system and are executed by the at least one processor, the one or more programs comprising:
a communication module operable to establish a wireless connection with the Internet television, send a detection message to the Internet television, and receive a first feedback corresponding to the detection message from the Internet television, wherein the detection message is used to request the Internet television to detect a text input area status of the television display, and the first feedback comprises the text input area status of the television display;
a text determining module operable to determine whether a cursor of the television display shows a text input area of the television display according to the first feedback, and determine a text type of the text input area according to the first feedback when the cursor of the television display shows the text input area of the television display;
a selecting module operable to select one of the input methods corresponding to the text type of the text input area; and
a text input module operable to input text in the text input area by use of the corresponding input method, wherein the communication module further transmits the input text to the Internet television.

2. The handheld device of claim 1, wherein the communication module further receives a second feedback corresponding to the input text from the Internet television, wherein the second feedback includes a plurality of complete words related to the input text.

3. The handheld device of claim 2, wherein the text input module determines whether the input text is a complete word, further determines whether remaining text is input by the corresponding input method when the input text is not a complete word, and continues to input the remaining text by the corresponding input method when the remaining text is input by the corresponding input text.

4. The handheld device of claim 3, wherein the text input module selects one complete word from the complete words included in the second feedback when the remaining text is not input by the corresponding input method, and the communication module transmits the selected complete word to the Internet television.

5. The handheld device of claim 4, further comprising a display module operable to display the input text, the complete words included in the second feedback, and the selected complete word.

6. A text input method of a handheld device wirelessly communicating with an Internet television comprising a television display, the text input method comprising:
providing a plurality of input methods corresponding to a plurality of text types;
establishing a wireless connection with the Internet television;
sending a detection message to the Internet television, wherein the detection message is used to request the Internet television to detect a text input area status of the television display;
receiving a first feedback corresponding to the detection message from the Internet television, wherein the first feedback comprises the text input area status of the television display;
determining whether a cursor of the television display shows a text input area of the television display according to the first feedback;
determining a text type of the text input area according to the first feedback when the cursor of the television display shows the text input area of the television display;
selecting one of the input methods corresponding to the text type of the text input area;
inputting a text in the text input area by use of the corresponding input method; and
transmitting the input text to the Internet television.

7. The text input method of claim 6, further comprising:
receiving a second feedback corresponding to the input text from the Internet television, wherein the second feedback includes a plurality of complete words related to the input text;
determining whether the input text is a complete word;
determining whether remaining text is input by the corresponding input method if the input text is not a complete word; and
continuing to input the remaining text by the corresponding input method if the remaining text is input by the corresponding input method.

8. The text input method of claim 7, further comprising:
selecting one complete word from the complete words included in the second feedback when the remaining text is not input by the corresponding input method; and
transmitting the selected complete word to the Internet television.
